(19) United States
(12) Patent Application Publication
(10) Pub. No.: US 2015/0010836 A1
(43) Pub. Date: Jan. 8, 2015

(54) EMERGENCY AIR PORT AND FUEL CELL SYSTEM HAVING THE SAME

(71) Applicant: HYUNDAI MOTOR COMPANY, Seoul (KR)

(72) Inventors: Jeong Hee Park, Suwon (KR); Chang Ha Lee, Yongin (KR)

(73) Assignee: HYUNDAI MOTOR COMPANY, Seoul (KR)

(21) Appl. No.: 14/047,229

(22) Filed: Oct. 7, 2013

(30) Foreign Application Priority Data
Jul. 8, 2013 (KR) 10-2013-0079529

(51) Int. Cl. H01M 8/04

(52) U.S. Cl. CPC H01M 8/04089; H01M 8/04126
USPC 429/413; 429/444

(57) ABSTRACT

An air cell system provided with emergency air port and an emergency air port is provided. In particular, an emergency port plate is provided between a suction block valve and a blower along air suction line of a fuel cell system or between a humidifier along an air suction line and a discharge block valve along an air discharge line and a wire is connected to the emergency port plate accordingly. Additionally, an operating assembly which enables the air suction line or the air discharge line to be in fluid communication with an external environment by pulling a wire to brake the emergency port plate when the suction block valve or the discharge block valve is not operating properly is also provided to provide a failsafe system for valve failure.

### CROSS-REFERENCE TO RELATED APPLICATION

This application claims under 35 U.S.C. §119(a) priority to Korean Patent Application No. 10-2013-0079529 filed Jul. 8, 2013, the entire contents of which are incorporated herein by reference.

### BACKGROUND

(a) Technical Field

The present disclosure relates to an emergency air port and a fuel cell system having the emergency air port, capable of starting the fuel cell by opening emergently the emergency air port for air to be ventilated when a suction block valve or a discharge block valve of the fuel cell system breaks down.

(b) Background Art

Generally, an air block valve which blocks airflow into a stack during parking has been applied to a fuel cell vehicle in order to improve the durability of the stack. However, when the air block valve is not operating properly, the passage is blocked and thus a problem arises in that it is impossible to start or drive the vehicle. In this case, the vehicle has to be towed away and repaired, and thus it requires a lot of time and expense. The present invention has been made in order to be able to drive emergently the fuel cell vehicle without towing the vehicle away by providing an emergency port in the air passage when the air block valve is not operating properly.

Currently, the air block valves at an entrance/exit port are typically opened normally for the fuel cell vehicle to receive air effectively and to generate an output of power after the fuel cell vehicle is turned on. Furthermore, the air block valves at an entrance/exit port have to be closed to block airflow into the stack in order to improve the durability thereof when the fuel cell vehicle is turned off.

In an air block valve of a general Butterfly type valve assembly, a clearance between a valve plate and a bore is to be kept at a minimal distance apart to improve an air block performance because as air block performance becomes increases, the time for maintaining the durability of the stack increases.

As such, there arises a problem in that it is often impossible to start and drive the fuel cell vehicle because when the fuel cell vehicle is turned off, the air block valve is continuously maintained in a closed state, and further an air passage at an air side is blocked completely when the air block valve is not operating properly. In this case, the vehicle has to be towed away and repaired, and thus it requires a lot of time and expense.

The description provided above as a related art of the present invention is only for helping in understanding the background of the present invention and should not be construed as being included in the related art known by those skilled in the art.

### SUMMARY OF THE DISCLOSURE

The present invention has been made in an effort to solve the above-described problems associated with the related art and it is an object of the present invention to provide an emergency air port and a fuel cell system having the emergency air port through which it is possible to start the fuel cell by opening emergently the emergency air port for air to be ventilated when a suction block valve or a discharge block valve of the fuel cell system is not operating properly.

In order to achieve the object of the present invention, the present invention provides an emergency air port, including: an emergency port plate provided between a suction block valve and a blower along an air suction line of a fuel cell system or between a discharge block valve and a humidifier along air discharge line. A wire connected to the emergency port plate is also provided along with an operating assembly which enables the air suction line or the air discharge line to be ventilated to the outside by pulling the wire to break the emergency port plate when the suction block valve or the discharge block valve is not operating properly.

In the emergency air port, the emergency port plate may be provided to close the emergency port formed in an air exit side of the suction block valve and/or the air discharge side of a humidifier. As such, the emergency port plate may be provided to close the emergency port formed in the air discharge side of a humidifier.

The humidifier may be provided with a housing therein in which an air passage is formed, and the emergency port which is communicated to the outside is provided in the housing at an air passage of the air discharge side of the humidifier, and the emergency port plate may be provided to close the emergency port accordingly. In addition, the suction block valve and the discharge block valve may be normal-close types, and are opened when the fuel cell is started.

An operating knob provided in the interior of the vehicle may be operably connected to the operating assembly and one end of the wire may be connected to the emergency port plate and other end of the wire may be connected to the operating knob. As such, the wire is pulled when a user operates the operating knob. A motor may be operably connected to the operating assembly, and one end of the wire is connected to the emergency port plate and other end of the wire is connected to the motor, and thus the wire is pulled when the motor is operated.

A fuel cell system having an emergency air port according to the present invention, may include: an air suction line and an air discharge line connected to the humidifier; a suction block valve and a blower provided to the air suction line. Additionally, the system may include an emergency port plate provided between the air suction block valve and the blower as well as a wire connected to the emergency port plate and an operating assembly which enables the air suction line to be communicated to the outside by pulling a wire to break the emergency port plate when the suction block valve is not operating properly. The emergency port plate may in this embodiment be provided to close the emergency port formed in the air exit side of the suction block valve.

The fuel cell system having an emergency air port may further include: a discharge block valve provided to the air discharge line; and an emergency port plate provided between the humidifier and the discharge block valve. The humidifier may be provided with a housing therein, in which an air passage is formed, and the emergency port which is communicated to the outside is provided in the housing within an air passage of the air discharge side of the humidifier, and the emergency port plate may be provided to close the emergency port.

### BRIEF DESCRIPTION OF THE DRAWINGS

The above and other features of the present invention will now be described in detail with reference to certain exemplary embodiments thereof illustrated by the accompanying drawings which are given herein below by way of illustration only, and thus are not limitative of the present invention, and wherein:

FIG. 1 is a view showing the configuration of a fuel cell system having an emergency air port according to an exemplary embodiment of a present invention;

FIG. 2 is a cross-sectional view showing an emergency air port according to an exemplary embodiment of a present invention; and.

FIGS. 3 to 4 are views showing a portion in which an emergency air port is provided according to an exemplary embodiment of a present invention.

### DETAILED DESCRIPTION

Hereinafter, an emergency air port and a fuel cell system having the emergency air port according to an exemplary embodiment of the present invention will be described, referring to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid fuel cell vehicles, electric fuel cell vehicles, combustion, plug-in hybrid electric fuel cell vehicles, hydrogen-powered vehicles, and other alternative fuel cell vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

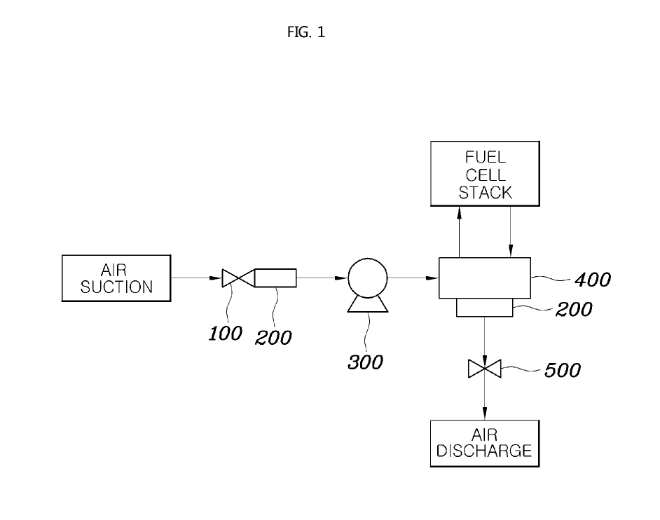

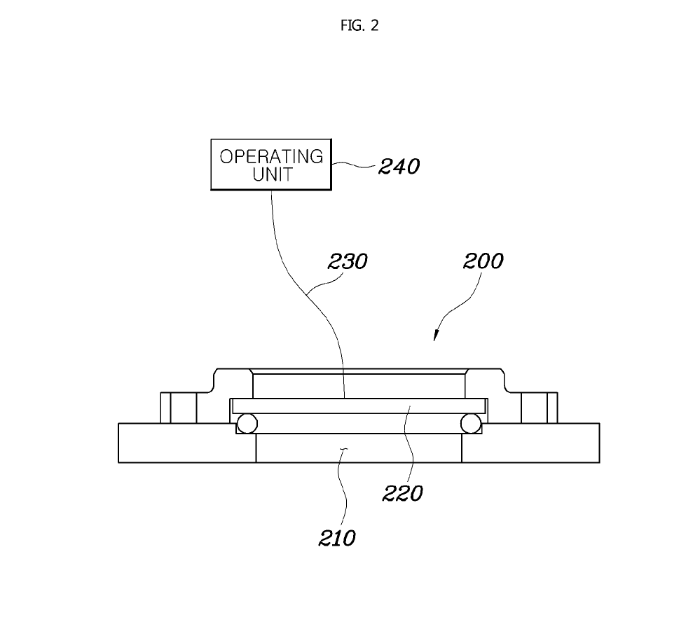

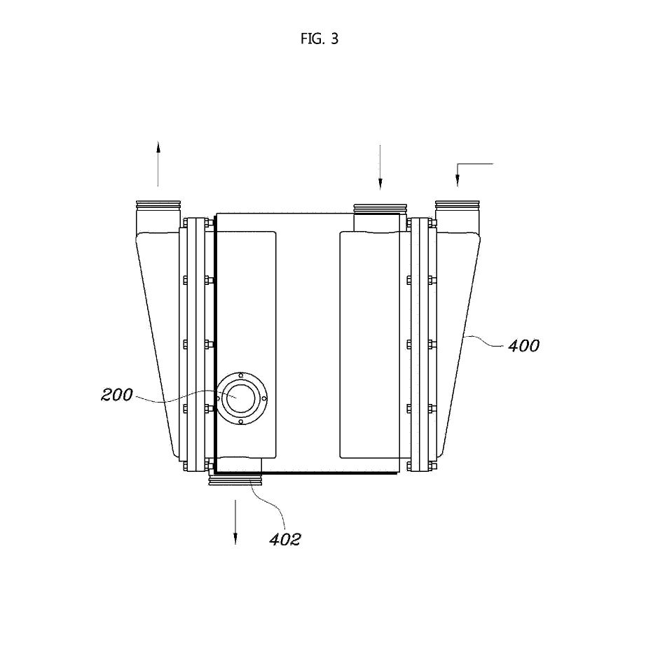

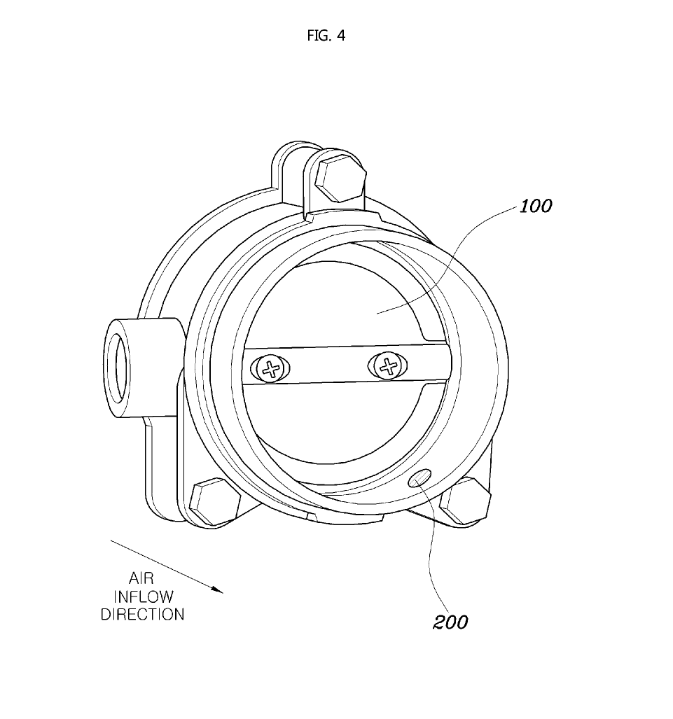

FIG. 1 is a view showing the configuration of a fuel cell system having an emergency air port according to an exemplary embodiment of the present invention, FIG. 2 is a cross-sectional view showing an emergency air port according to an exemplary embodiment of the present invention, and FIGS. 3 to 4 are views showing a portion in which an emergency air port is provided according to an exemplary embodiment of the present invention.

An emergency air port 200 according to an exemplary embodiment of the present invention include: an emergency port plate 220 which is provided between a suction block valve 100 and a blower 300 along an air suction line of a fuel cell system and/or between a humidifier 400 and a discharge block valve 500 along an air discharge line; a wire 230 operably connected to the emergency port plate 220; and an operating assembly 240 which enables the air suction line or the air discharge line to be ventilated to the outside by pulling a wire 230 by breaking the emergency port plate 220 when the suction block valve 100 or the discharge block valve 500 is not operating properly.

FIG. 1 is a view showing a configuration of a fuel cell system having an emergency air port according to an exemplary embodiment of the present invention wherein specifically, the whole fuel cell system having the emergency air port according to a present invention include: an air suction line or an air discharge line connected to a humidifier 400; a suction block valve 100 and a blower 300 provided to the air suction line; an emergency port plate 220 (See FIG. 2) provided between the suction block valve 100 and the blower 300; a wire 230 (See FIG. 2) connected to the emergency port plate 220; and an operating assembly 240 (See FIG. 2) which enables the air suction line to be ventilated to the outside by pulling a wire 230 to break the emergency port plate 220 when the suction block valve 100 is not operating properly.

The air suction line and the air discharge line may be provided in the fuel cell system for inflow and discharge of air, respectively. The emergency port plate may be provided between the suction block valve and the fuel cell stack along the air suction line or between the discharge block valve and the fuel cell stack along the air discharge line. For example, in one embodiment of the present invention, when the valve is in the air suction line, air is introduced from outside the system and passes through the suction block valve 100, and an inflow power is received from the blower 300 to be introduced in the humidifier 400 and the humidified air flows into the fuel cell.

Meanwhile, the air after operating, discharges to the outside through the air discharge line to which the discharge block valve 500 is provided after passing through the humidifier 400. The suction block valve 100 and discharge block valve 500 are provided in the air suction line and air discharge line, respectively, because it is essential to block airflow therein from the outside when a starting of engine is stopped in a case of a fuel cell. However, this suction block valve 100 and discharge block valve 500 are required to be opened for starting the fuel cell, and thus the starting of the fuel cell is impossible when these block valves are not operating properly. Accordingly, to avoid this situation where the starting of the fuel cell is impossible, the emergency air ports 200 are provided within the air suction line and the air discharge line, respectively.

More specifically, the emergency port plate may be provided to close the emergency port 210 which is formed in the air exit side of the suction block valve 100 when it is installed on a suction side. Moreover, the emergency port plate 220 may be provided to close the emergency port 210 when it is formed in the air exit side of the suction block valve 100.

As shown in the FIG. 4, air flows into one side of the suction block valve 100 and is discharged from other side of the suction block valve 100. The emergency port 210 is provided on the air exit side of this suction block valve 100 to be in fluid communicated with an external environment. Here, this emergency port 210 is to be blocked with the emergency port plate 220 during normal operation.

Furthermore, the emergency port plate 220 may be provided to close the emergency port 210 which is formed in an air discharge side of the humidifier 400. Specifically, as shown in FIG. 3, the humidifier 400 is provided with a housing therein in which an air passage is formed, and the emergency port 210 which is fluidly communicative to an external environment is provided in the housing within an air passage of the air discharge side of the humidifier 400, and the emergency port plate 220 may be provided to close the emergency port 210 accordingly.

That is, air passages for the inflow and discharge of air may be formed inside the humidifier 400, and the emergency port 210 may be formed within the air passage of the air discharge side of the humidifier 400. Here, the air passage of the emergency port 210 may be blocked with the emergency port plate 220 during normal operation.

Moreover, as shown in FIG. 2, a wire 230 is connected to the emergency port plate 220. As such, the wire is to be pulled when the operating assembly 240 (e.g., an operation knob) is operated to break the emergency port plate. As a result, outside air may be drawn through the blower 300 to be introduced to the humidifier even though the suction block valve 100 is not operating properly, or the air may be blown outside even though the discharge block valve 500 is not operating properly and not opened.

In some exemplary embodiments, the suction block valve 100 and the discharge block valve 500 may be in some embodiments, normal-close types, and may be opened when the fuel cell is started.

In addition, an operating knob which is formed in an indoor side is provided to the operating assembly 240 which pulls the wire 230. Here, one end of the wire 230 is connected to the emergency port plate, and other end of the wire is connected to the operating knob, and thus the wire may be pulled when a user operates the operating knob. That is, the wire may be pulled to be-linked with the operating of the operating knob when a user operates the operating knob in the interior of the vehicle on, for example a dashboard.

Furthermore, a motor may be provided to operate the assembly automatically, and one end of the wire may be connected to the emergency port plate and other end of the wire may be connected to the motor, and thus the wire may be pulled when the motor is operated either on its own or by operator command.

According to the emergency air port and the fuel cell system having the emergency air port, as configured above, generally, the air block valve is provided within a location that is difficult for an individual to separate/install the valve by hand because the air block valve serves to block the air passage at the entrance/exit port of the stack. Therefore, a vehicle is often required to be towed to a vehicle repair service center since it is very difficult to replace the components at a site where the air block valve fails. However, in the case of the present invention, it is possible to drive emergently the fuel cell system to the repair facility by removing the emergency port plate without the towing process of the vehicle via a simple operation of the operation assembly, thereby removing the towing process of vehicle and saving the time expense of a driver.

Additionally, according to an emergency air port and a fuel cell system having the emergency air port of the present invention, the component provided with an emergency port can be made in a simple manner, and thus save repair costs even when the plate is removed and replaced when the air block valve is not operating properly.

While the invention will be described in conjunction with exemplary embodiments, it should be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. An emergency air port comprising:
an emergency port plate provided between a suction block valve and a fuel stack along an air suction line of a fuel cell system or between a discharge block valve and the fuel cell stack along an air discharge line;
a wire connected to the emergency port plate; and
an operating assembly which enables the air suction line or the air discharge line to be in fluid communication with an external environment by pulling a wire to break the emergency port plate when the suction block valve or the discharge block valve is not operating properly.

2. The emergency air port of claim 1, wherein the emergency port plate is provided between the suction block valve and a blower along air suction line of a fuel cell system or between a humidifier and the discharge block valve along air discharge line.

3. The emergency air port of claim 2, wherein the emergency port plate is provided to close the emergency port which is formed on an air exit side of the suction block valve.

4. The emergency air port of claim 2, wherein the emergency port plate is provided to close the emergency port formed on the air discharge side of a humidifier.

5. The emergency air port of claim 4, wherein the humidifier is provided with a housing therein where an air passage is formed, and the emergency port, which is in fluid communication with the external environment, is provided in the housing within an air passage of the air discharge side of the humidifier, and the emergency port plate is provided to close the emergency port.

6. The emergency air port of claim 1, wherein the suction block valve and the discharge block valve are normal-close types, and are opened when the fuel cell is started.

7. The emergency air port of claim 1, wherein an operating knob installed in an interior of a vehicle embodies the operating assembly, and one end of the wire is connected to the emergency port plate and other end of the wire is connected to the operating knob, wherein the wire is pulled when a user operates the operating knob.

8. The emergency air port of claim 1, wherein the operating assembly is embodied as a motor, and one end of the wire is connected to the emergency port plate and other end of the wire is connected to the motor, wherein the wire is pulled when the motor is operated.

9. A fuel cell system having an emergency air port comprising:
an air suction line and an air discharge line connected to a humidifier;
a suction block valve and a blower provided within the air suction line;
an emergency port plate provided between the air suction block valve and the blower;
a wire connected to the emergency port plate; and
an operating assembly enabling the air suction line to be in fluid communication with an external environment by pulling a wire to break the emergency port plate when the suction block valve is not operating properly.

10. The fuel cell system having an emergency air port emergency air port of claim 9, wherein the emergency port plate is provided to close the emergency port formed in the air exit side of the suction block valve.

11. The fuel cell system having an emergency air port of claim 9, further comprising: a discharge block valve provided within the air discharge line; and an emergency port plate provided between the humidifier and the discharge block valve.

12. The fuel cell system having an emergency air port emergency air port of claim 11, wherein the humidifier is provided with a housing therein where an air passage is formed, and the emergency port in fluid communication with the external environment is provided in the housing within an air passage of the air discharge side of the humidifier, and the emergency port plate is provided to close the emergency port.

13. A method comprising;
determining that a valve air port valve in a fuel cell system is not operating correctly; and
in response to determining that the air port valve is not operating correctly, operating an operating assembly that pulls a wire to break an emergency port plate in the valve to allow air to be provided to a humidifier in the fuel cell assembly even when the valve fails.
